(19) United States
(12) Patent Application Publication
(10) Pub. No.: US 2006/0252023 A1
(43) Pub. Date: Nov. 9, 2006

(54) Methods for automatically identifying user selected answers on a test sheet

(75) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/120,934

(22) Filed: May 3, 2005

(51) Int. Cl. G09B 3/00; G09B 7/00

(52) U.S. Cl. 434/353

(57) ABSTRACT

Methods for automatically grading multiple choice tests using test question sheets marked by a test-taker. Image processing algorithms automatically recognize the circled answer selections on the test question sheets. Using the invention multiple choice tests may be scanned and graded automatically without the use of bubble sheets, thereby simplifying and reducing the cost of testing.

### FIELD OF THE INVENTION

The present invention relates generally to methods for identifying user made marks on a sheet of paper, and more specifically, to methods for automatically identifying circled answers made by a test-taker on a multiple choice examination sheet.

### BACKGROUND OF THE INVENTION

The automatic grading of multiple choice tests has traditionally been accomplished through the use of bubble sheets. The process involves providing test-takers with test question sheets, usually containing multiple-choice questions, and a corresponding bubble sheet for recording their answers. Each bubble sheet contains several pre-printed hollow bubbles for each question number, and the pre-printed hollow bubbles correspond to answer choices for each test question. Test-takers generally designate their answer choices by filling in the pre-printed hollow bubbles that correspond to desired answer choices of the test questions. To be graded, the filled-in or marked bubble sheets have to be fed into specialized bubble sheet reading machines. Such a process is often cumbersome, expensive, and restrictive due to the use of specialized bubble sheet reading machines. Further, because bubble sheets have to be designed, printed, and distributed in addition to the test question sheets, additional costs and efforts are incurred. As a result, oftentimes only formal or standardized tests are conducted using this process.

The use of bubble sheets can be a source of grief for test-takers as well. Test-takers must take special care to bubble in the correct answer choice for the correct test question. For instance, if a test-taker were to accidentally skip a question when bubbling in answers on the bubble sheet, then a series of answer choices may be marked incorrect. Test-takers who attempt to avoid such errors by marking their answer choices on their question sheets first, and intending to bubble in the answers later, may run out of time to transfer the answers onto their bubble sheets. These problems place additional stress on test-takers.

Thus, there remains an unsatisfied need in the industry for a simple, reliable, and efficient method for automatically grading tests without the use of separate bubble sheets.

### BRIEF SUMMARY OF THE INVENTION

Methods for automatically grading tests using test question sheets marked by a test-taker utilize image processing algorithms to automatically recognize the circled answer selections on the test question sheets. Marked test question sheets may be scanned by an optical scanner and graded automatically without the use of bubble sheets, thereby simplifying testing while significantly reducing the cost of tests.

According to one embodiment of the invention, there is disclosed a method of identifying a user-selected answer. The method includes scanning a marked copy of an answer sheet, where the marked copy includes a marking corresponding to a user-selected answer of a plurality of answer choices, and comparing at least one portion of the marked copy to a corresponding at least one portion of the unmarked version of the answer sheet. The method also includes identifying differences between the at least one portion of the marked copy and the corresponding at least one portion of the unmarked version, and based on the identified differences, determining the user-selected answer.

According to one aspect of the invention, the method also includes the step of generating a digital pixel map of the unmarked answer sheet, and generating a digital pixel map of the marked copy. According to another aspect of the invention, the step of comparing may further include the step of comparing at least one answer region of the marked copy to a corresponding answer region of the unmarked version, where the respective answer regions of the marked copy and unmarked version encompass at least one of the plurality of answer choices. According to yet another aspect of the invention, the step of comparing may include the step of comparing a digital pixel map of the answer region of the marked copy to a digital pixel map of the corresponding answer region of the unmarked version.

The method may also include the step of creating a difference map, where the difference map shows at least some of the differences between the marked copy and the unmarked version. According to one aspect of the invention, the step of creating a difference map may include creating a digital difference map that identifies at least some of the pixel differences between the digital pixel map of the marked copy and the digital pixel map of the unmarked version. Further, the step of creating a difference map may include creating a digital difference map that identifies the pixel differences between an answer region in the digital pixel map of the marked copy and a corresponding answer region in the digital pixel map of the unmarked version.

According to another aspect of the invention, the method may also include the step of determining the number of pixels that are different in the answer region of the marked copy compared to the corresponding answer region of the unmarked version. According to yet another aspect of the invention, the step of identifying differences may also include the step of measuring the similarity between the at least one portion of the marked copy and the corresponding at least one portion of the unmarked version, where the similarity measurement is based on a correlation computation.

According to another embodiment of the invention, there is disclosed a method of identifying user-selected answers. The method includes scanning an answer sheet, where the answer sheet includes at least one marking corresponding to a user-selected answer, comparing a first region of the scanned answer sheet to a corresponding first region of an unmarked version of the answer sheet, identifying the differences between the first region of the scanned answer sheet and the corresponding first region of the unmarked version of the answer sheet, and determining the user-selected answer based on the identified differences.

According to one aspect of the invention, the method may further include the step of comparing a second region of the scanned answer sheet to a corresponding second region of the unmarked version of the answer sheet. The method may also include the steps of establishing a first rank based on the identified differences between the first region of the scanned answer sheet and the corresponding first region of the unmarked version of the answer sheet, and establishing a second rank based on the identified differences between the second region of the scanned answer sheet and the corresponding second region of the unmarked version of the answer sheet. According to one aspect of the invention, the step of determining the user-selected answer may include the step of determining the user-selected answer by comparing the first rank and the second rank. The step of identifying the differences may also include the step of generating a difference map based on the identified differences between the first region of the scanned answer sheet and the corresponding first region of the unmarked version of the answer sheet.

According to another aspect of the invention, the step of identifying the differences may also include the step of determining the number of pixels that are different in the first region of the scanned answer sheet from the corresponding first region of the unmarked version of the answer sheet. According to yet another aspect of the invention, the method includes comparing a second region of the scanned answer sheet to a corresponding second region of the unmarked version of the answer sheet, and determining the number of pixels that are different in the second region of the scanned answer sheet from the corresponding second region of the unmarked version of the answer sheet. The number of pixels that are different in the first region of the scanned answer sheet may also be compared to the number of pixels that are different in the second region of the scanned answer sheet.

According to another aspect of the invention, the method may include the step of storing the location of an answer on the answer sheet. The location of the corresponding first region of the unmarked version of the answer sheet may also be stored. According to yet another aspect of the invention, the method may include the step of increasing the size of the first region of the scanned answer sheet and the corresponding first region of the unmarked version of the answer sheet.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an illustrative example of a multiple choice problem having a user-circled answer marking.

FIG. 2 shows an illustrative example of a difference map after the marked multiple choice problem of FIG. 1 is compared to an unmarked copy of the multiple choice problem, according to one aspect of the present invention.

FIG. 3 shows an illustrative example of a multiple choice problem having a user-circled answer marking.

FIG. 4 shows an illustrative example of a difference map after the marked multiple choice problem of FIG. 3 is compared to an unmarked copy of the multiple choice problem, according to one aspect of the present invention.

FIG. 5 shows a flow chart illustrating an answer recognition method, according to one embodiment of the present invention.

FIG. 6 shows a block diagram of an answer recognition module, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

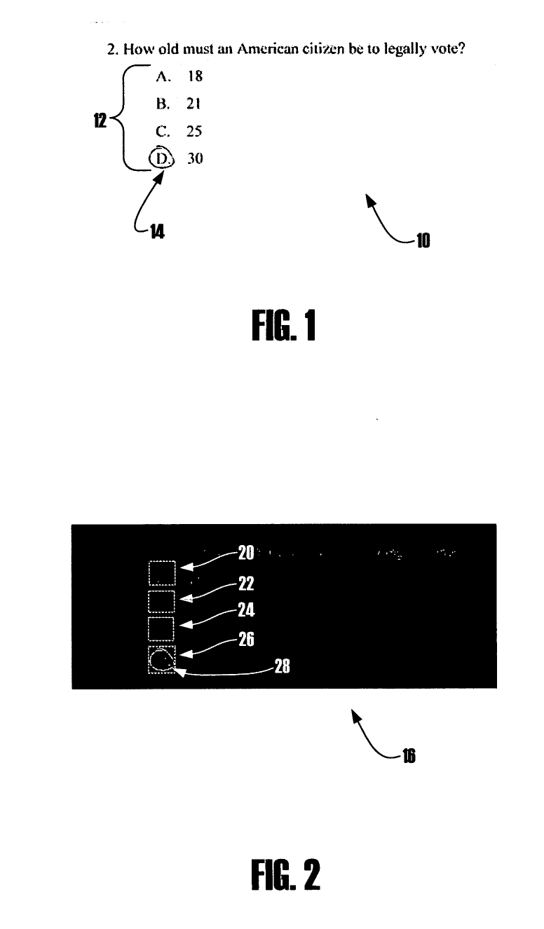

Referring now to FIG. 1, multiple choice tests normally designed for human grading are usually administered to test-takers who are instructed to circle the correct answer (e.g., an A, B, C, or D answer choice) for each question. FIG. 1 shows an illustrative example of a simple multiple choice problem 10 providing a test-taker a choice of answer choices 12 to a multiple choice question. The multiple choice problem 10 of FIG. 1 has already been administered to a test-taker, and includes a marking 14 designating the user's answer selection. As shown in FIG. 1, the marking 14 is a small, handwritten circle around answer choice ‘D’.

According to one aspect of the invention, the test-taker's answer selection may be automatically identified by scanning the completed multiple choice problem 10 and comparing the completed multiple choice problem 10 to an unmarked version of the problem. The unmarked version of the problem is a clean copy of the problem prior to receiving the test-taker's marking 14. The comparison may be performed using digital copies of both the completed multiple choice problem (i.e., the test-taker's marked copy) and an unmarked version. Although both the marked copy and the unmarked version may be converted into digital form by a scanner, the unmarked version may be generated in digital form and stored as a master copy of the test so that subsequent scanning of the document is unnecessary to place it in digital form.

As is well known in the art, a scanner may capture images of the marked copy and convert it into a digital pixel map, which allows for computer processing of the digital pixel map. A digital pixel map of the unmarked version is also used for processing, which, as noted above, may be generated by a scanner or may be the digitally generated master copy. According to one aspect of the invention, a direct pixel map comparison of the marked copy and the unmarked version may be made to identify the changes the test-taker has made to the test. As will be discussed with respect to FIG. 6, this comparison may be executed by a computer program product that receives the digital copies of the marked copy and the unmarked version.

Although a direct pixel map comparison may be made to the entire digital versions of the unmarked version and marked copy, only corresponding portions of each are preferably compared. For instance, only one or more answer regions around the answer choices may be compared on the unmarked version and the marked copy. According to one aspect of the invention, a square region around each answer alternative on the marked copy may be compared to the same square region around each answer choice on the unmarked version. Based on a comparison of the pixel maps of each copy, the differences between the marked copy and unmarked version, or between the respective portions or answer regions thereof, may be identified. Based on these identified differences, the user-selected answer may be determined.

FIG. 2 shows an illustrative example of a difference map 16 generated by a direct pixel map comparison of the marked multiple choice problem 10 of FIG. 1 with an unmarked version of the problem, according to one aspect of the present invention. The difference map 16 illustrates the differences between the two pixel maps by displaying the pixels that are different in white. Because the only difference between the marked multiple choice problem 10 and the unmarked version is the marking 14, the user's answer selection 28 appears in white.

As described above, a direct pixel map comparison may be made only to selected regions of a marked copy of a test and an unmarked version of the same test. Reducing the size of the direct pixel map comparison maximizes speed of the comparison and minimizes the memory and computing power required to execute the comparison. This may be particularly important where a test includes a large number of multiple choice problems on the same or multiple pages. The illustrative embodiment of FIG. 2 shows square regions 20, 22, 24, 26 around each answer choice, where each square region 20, 22, 24, 26 is illustrated with dashed lines. Thus, the pixels in each square region 20, 22, 24, 26 on the marked copy may be compared to the same region on the unmarked version.

Defining answer regions, such as a square region around each answer choice, also enables a comparison to occur between the regions to identify the answer region that has changed the greatest from the unmarked version. According to one aspect of the invention, the difference in the number of pixels provided within each answer region 20, 22, 24, 26 of the difference map may be used as an indicator as to which of the four answer choices is marked and selected. According to one aspect of the invention, the number of pixels within each answer region in the difference map may be counted to determine the answer region containing the greatest number of pixel differences from the unmarked version. The greater the number of pixel differences, the greater the changes within the region. Because a test-taker's marking results in pixel differences in the difference map, the answer region in which the marking was made may be identified. In the illustrative example of FIG. 2, the answer region 26 around answer choice ‘D’ contains the greatest number of pixels in the difference map. Therefore, the answer region corresponding to ‘D’ is identified as the test-taker's answer selection.

It will be appreciated that the answer regions 20, 22, 24, 26 may be defined around each answer choice during the creation of a problem or test. According to one aspect of the present invention, when a digital copy of a problem or test is generated, the location of each answer choice letter is stored in a database. As noted above, the unmarked version may be formed digitally as a master copy such that scanning of an unmarked version is not required. According to one aspect of the invention, the location of each answer choice letter may be stored in a database. One or more tests may be digitally created from a collection of stored test questions, such that each test may automatically store the location of each answer choice letter used.

A base answer region covering each answer letter may also be stored. According to one aspect of the invention, the answer region may be based on the location of each answer choice letter, for instance, the letters ‘A’, ‘B’, ‘C’, or ‘D’ in FIG. 1. According to one aspect of the invention, a base answer region may be a square defined by the coordinates of a corner of an answer choice letter in combination with a width and height of the letter depending on the font used. Because the width and height of individual answer choice letters may vary, the size of the base answer regions for answers to a single question may vary. Alternatively, a predetermined base answer region may be used for each answer choice letter. It will be appreciated by those of skill in the art that other method for establishing digital answer regions may be used based on a digital pixel map of a multiple choice question and/or test, as is described in co-pending U.S. patent application titled “Methods For Identifying Marks Using A Digital Master Document And Scanned Image Enhancement”, filed contemporaneously herewith, and assigned to Lexmark International, Inc., the entire contents of which are incorporated herein by reference as if set forth fully herein. Regardless of the method used, the location and size of each answer region is used to identifying the changes within that answer region when corresponding regions from marked and unmarked copies are compared. Additionally, although it is preferred that square regions be used, as is shown in FIG. 2, other answer regions may also be defined, so long as the answer regions do not overlap each other, or two or more answer choices. For instance, circular regions could be used.

Using a direct pixel map comparison and a difference map to identify answers is effective when a test-taker marks answers using circles or equivalent marks that are of a minimum size in circumference to encircle a chosen answer, but not too large so that the marking impedes on answer choices. However, test-takers do not mark each answer choice consistently, as the test-takers' circular markings may differ in length, width, shape, and orientation from question to question. Furthermore, some test-takers mark answers differently from other test-takers. These problems result in some instances where the method described above with respect to FIGS. 1 and 2 may have difficulty with identifying the test-taker's answer selection. For example, when a test-taker circles an answer with a circle large enough to touch the adjacent answers, the number of pixel differences within an answer region, as identified by a difference map, may not accurately identify a user's selected answer.

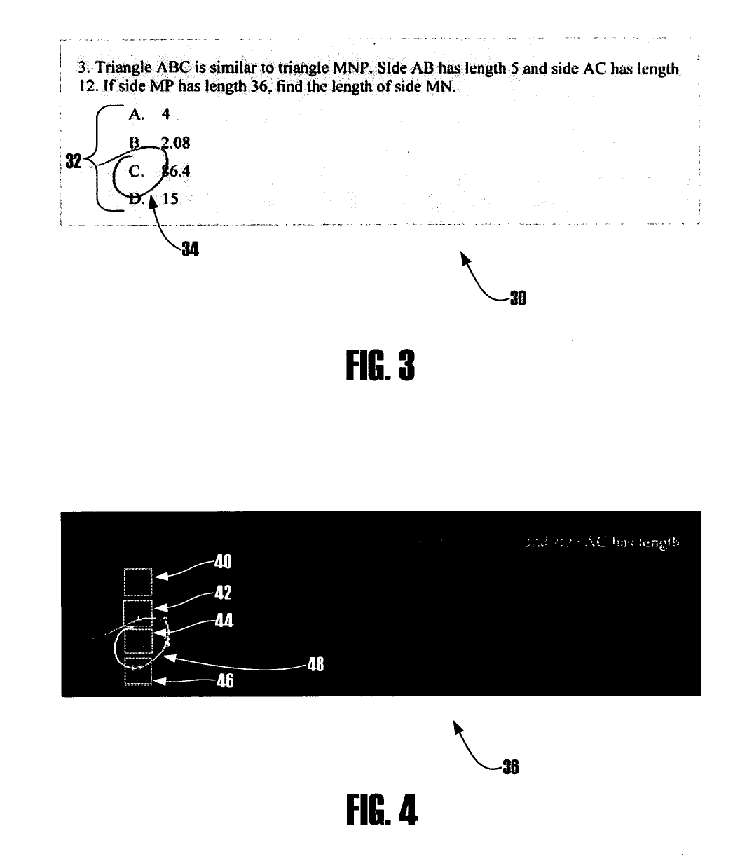

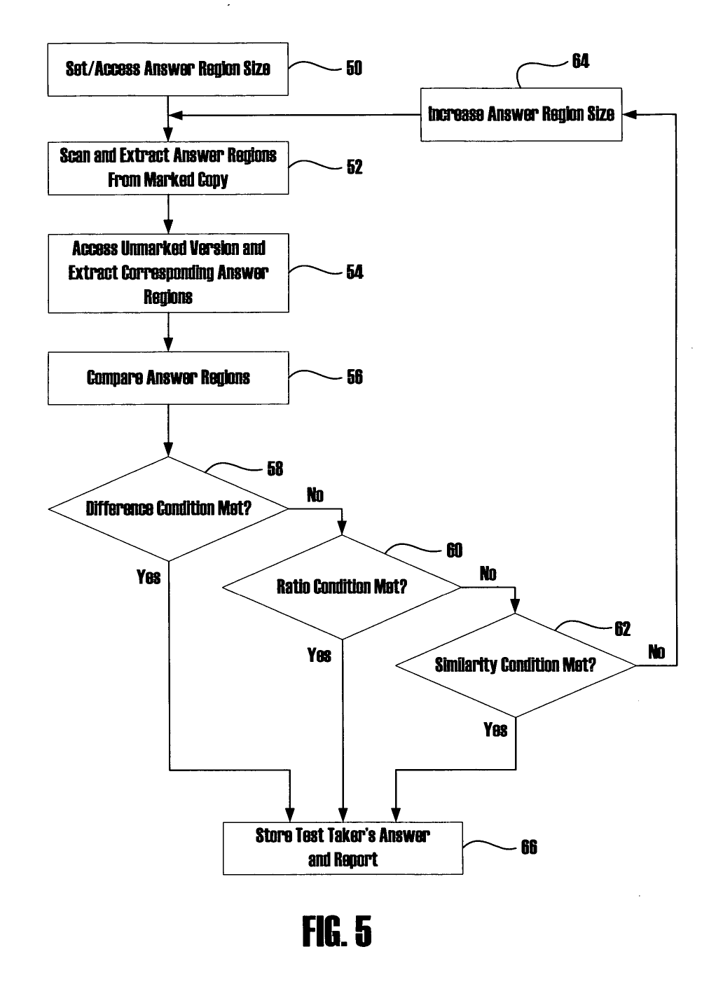

FIG. 3 shows an illustrative example of a multiple choice problem 30 having a marking 34 identifying a test-taker's answer. The marking 34, which designates answer ‘C’, is large in circumference and traverses at least a part of the space provided for other answer choices 32, including answers ‘B’ and ‘D’. This marking 34 may be referred to as an over-drawn answer circle. In this example, using a direct pixel map comparison between answer regions on the marked copy and corresponding answer regions on the unmarked version, as described with respect to FIGS. 1 and 2, would result in an inaccurate identification of the test-taker's selected answer because large sections of the test-taker's marking 34 fall outside the answer region matching the selected answer. This is illustrated with respect to FIG. 4, which shows a difference map 36 illustrating the differences between the marked multiple choice problem 30 of FIG. 3 and an unmarked copy of the same multiple choice problem. More specifically, as shown in FIG. 4, each of the answer choices include corresponding square regions 40, 42, 44, 46, illustrated with dashed lines.

If only the square regions 40, 42, 44, 46 defined by the boxes in FIG. 4 are examined, it is not possible to accurately determine the test-taker's answer selection by using the number of different pixels, as provided by the difference map 36, as an indicator as to which of the four answer choices is marked and selected. Because the marking 34 is large, there may be a greater number of pixel differences within the square regions 42, 46 corresponding to answers ‘B’ and ‘D’. Because there are no pixel differences within the square region 44 associated with the test-taker's marked answer ‘C’, it is incorrect to assume that the test-taker's answer is identified by the square region demonstrating the greatest number of changes as provided by the difference map.

To overcome the problem presented by an over-drawn answer circle, such as the problem presented by the marking 34 illustrated in FIG. 3, the size of the square regions 40, 42, 44, 46 could be enlarged until they are of sufficient size to include the user marking, after which a direct pixel map comparison of answer regions may be made and the number of changes within a answer region, as provided in a difference map, may be used to identify the test-taker's answer. However, if the answer regions are too large, it may be difficult to perfectly align the marked-copy with the unmarked version to execute a comparison between answer regions. The printing and scanning of a test sheet may also introduce enough distortion to make perfect alignments for every answer region of a test sheet difficult or impossible. Additionally, there may be discrepancies, such as font discrepancies, between a digital copy of the unmarked version, such as a master copy, and a printed and scanned copy of a marked test sheet. Furthermore, misaligned pixels representing text and other information on the marked test sheet may also serve as noise to the recognition process, making the answer recognition method less reliable.

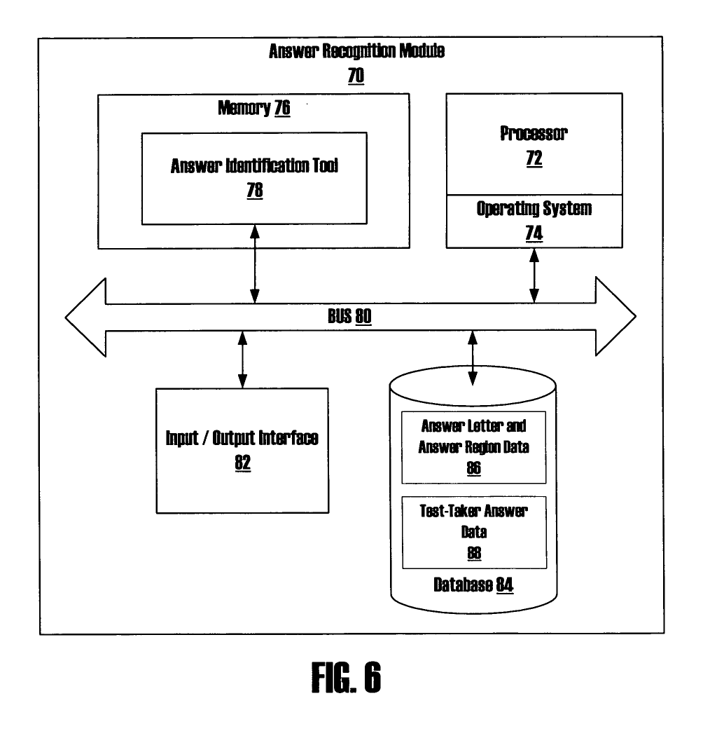

FIG. 5 shows a flow chart illustrating an answer recognition method, according to one embodiment of the present invention. The answer recognition method overcomes the problems presented by an over-drawn answer circle, such as the problems presented by the marking 34 illustrated in FIG. 3. The answer recognition method shown in FIG. 5 progressively increases the size of the answer regions from a base size until certain conditions are met. Because the conditions do not rely solely on a direct pixel map comparison of a marked copy and an unmarked version to generate a difference map that wholly determines the test-taker's answer, as described above with respect to FIGS. 1-4, a test-taker's answer selection may be identified even if there is an over-drawn answer circle and/or alignment, distortion and noise problems occur during the scanning and pixel map comparison process.

As shown in FIG. 5, a base answer region size is initially set (block 50) for each answer choice of a test question. According to one illustrative example, the base answer region size may be defined by a square having a number of pixels, such as 100 pixels corresponding to a 10 by 10 pixel answer region. According to another illustrative example, the base answer region size may be defined by a radius, where the answer region is circular. The size and location of each answer region is based upon the location of the answer letter, as described in detail above. As described above, this may occur during generation of individual test questions. According to one aspect of the invention, the base answer region size and location may be accessed from a local or remote database that stores answer letter and answer region data for each test question.

Next, using the known location of the answer regions, the answer regions corresponding to a single test question are extracted from a digital pixel map of a marked copy of a test sheet (block 52). Although it is preferred that the answer regions be extracted on a question by question basis, answer regions for multiple questions marked by a test-taker may also be extracted at once. It will be appreciated that extraction of a greater number of answer regions would require more computing power as location information for each answer region must be retrieved and used to extract the answer regions from a digital pixel map. For illustrative purposes, the remaining discussion will be with reference to the extraction of answer regions corresponding to a single multiple choice question.

Next, a digital pixel map of the unmarked version of the test, which may be the master copy, is accessed (block 54). The answer regions of the marked copy are then compared to the corresponding answer regions of the unmarked answer sheet (block 56). A difference map is generated (not illustrated), as described in detail with respect to FIGS. 1 and 2, which identifies the pixel differences within each answer region.

As shown in FIG. 5, the answer recognition method then determines whether a difference condition is met. To determine whether this condition is met, each answer region in a test question is ranked according to the number of differences within each answer region when compared to an unmarked version of the question, as provided by the difference map. As discussed in detail above, the number of differences within each answer region of the difference map be a count of the number of pixels in the difference map within each region. For instance, where there are four answer choices, the answer regions may be ranked R₁, R₂, R₃, and R₄, from the region having the most pixel differences (R₁) to the region having the least pixel differences (R₄). Next, the number of pixel differences between sets of regions may be directly compared to determine if one region has substantially more pixel differences than another region. According to one aspect of the invention, the number of pixels differences within a region R₁ may be divided by the number of pixel differences within region R₂. The same may occur for regions R₃ and R₄, where the number of pixel differences in region R₃ is divided by the number of pixel differences in R₄. Thereafter, if R₁/R₂ is substantially larger than R₃/R₄, then R₁ is identified as the test-taker's selected answer. According to one aspect of the invention, the difference condition is satisfied when R₁/R₂ is two times greater than R₃/R₄, although it will be appreciated that a ratio other than 2 to 1 may also be used to find that the difference condition is satisfied.

To illustrate the above computations, in the illustrative example of FIGS. 1 and 2, the answer region 26 corresponding to answer ‘D’ is ranked as the region having the most pixel differences as identified by the difference map 16. Therefore, that answer region 26 may be ranked R₁, and the remaining regions 20, 22, 24 as R₂-R₄, based on the number of pixel differences within each of those other regions (which may be more than 1 due to subtle noise, distortion and alignment issues.) Because the pixel differences within that region R₁ greatly outnumber the pixel differences in any of the remaining three answer regions, R₁/R₂ will be much greater than R₃/R₄ such that the difference condition is met and the test-taker's answer is identified. In the simple example of FIG. 1, this process therefore yields the same result as assuming that the answer region having the most differences is the test-taker's answer, due to the overwhelming difference in the number of different pixels in one answer region over the other regions.

The difference condition computation may also be illustrated with respect to the illustrative example of FIGS. 3 and 4. In that example, the answer regions 42, 46 corresponding to answers ‘B’ and ‘D’ have the most pixel differences, as identified in the difference map 36. However, the answer region 44 corresponding to answer ‘C’ is the test-taker's answer. Therefore, the answer regions 42, 46 corresponding to answers ‘B’ and ‘D’ will be ranked R₁ and R₂, either respectively or vice versa, depending on the pixel count within those regions in the difference map 36. On the other hand, the answer regions 40, 44 corresponding to answers ‘A’ and ‘C’ will be ranked R₃ and R₄ (or vice versa). Taking the ratio of R₁/R₂ may provide a result close to 1, as R₁ does not have an overwhelmingly greater number of pixel differences than R₂. Therefore, R₁/R₂ will not exceed the ratio of R₃/R₄ by a large enough margin to satisfy the difference condition. Therefore, although the answer regions 42, 46 corresponding to answers ‘B’ and ‘D’ have the most pixel differences, neither is presumed to be the test-taker's answer choice.

It will be appreciated that although the above process is described with reference to a test question having four answer choices, the above process may also be implemented with questions having a greater or fewer number of answer choices. Regardless of the number of choices, each answer region may be ranked and then compared with other regions in the manner described above. Where an odd number of answer choices exist, this may require multiple comparisons to occur, each which may have to satisfy a difference condition. Additionally, it will be appreciated that because ratios are taken, it may be presumed that the lowest number of pixel differences within any region is 1, to avoid ratios having a denominator of 0.

If the difference condition is satisfied (block 58), the test-taker's answer for the question is stored (block 66). Alternatively, if the difference condition is not satisfied, the answer recognition method will then determine if a ratio condition is met (block 60). Like the difference condition computation, the ratio condition is dependent upon the number of difference pixels within each answer region, as provided by a difference map after a comparison of pixel maps of a marked copy and an unmarked version of the same question or test. Because the ratio condition is considered only if the difference condition is not satisfied, and the difference condition is dependent upon difference map computation, the difference map does not have to be regenerated to determine if the ratio condition is satisfied.

It will be appreciated by those of ordinary skill in the art that an area of a digital region, such as an answer region, may be defined as the number of pixels within the region. Therefore, in a difference map, an answer region containing a test-taker's marking should have a larger area than an answer region that fails to contain the test-taker's marking. The pixels that comprise the user's (typically circular) mark should normally be greater than the pixels that make up an answer letter, or that are required to encircle an answer letter. This relationship may be impacted by the font type and size used for alternative test answers, and by the thickness of the user's marking. According to one aspect of the invention, the ratio between the total number of pixels used for a test-taker's marking and the total number of pixels used in generating an answer letter may be used to identify a test-taker's answer selection. According to one aspect of the invention, this ratio should be equal or greater than 2. When such a condition is met, the ratio condition is satisfied, and the test-taker's answer is presumed identified. As with the difference threshold, the ratio does not have to be exactly equal to two, although it will be appreciated that the greater the ratio, the more likely it is that a test-taker's answer is accurately identified.

It will be appreciated that the ratio condition is unlike the difference condition, and unlike the method described with respect to FIGS. 1 and 2, because the ratio condition is not dependent upon a comparison of two or more answer regions. Rather, the ratio condition is dependent only on the number of pixel differences within a region, and a comparison of those pixel differences to the number of pixels making up the corresponding answer letter. The number of pixels used in generating an answer letter may be stored and accessed along with the location of the letter, or all letters may be presumed to have a particular area where varied fonts are not used to generate the answer selections.

If the ratio condition is satisfied (block 60), the test-taker's answer for the question is stored (block 66). Alternatively, if the ratio condition is not satisfied, the answer recognition method will next determine if a similarity condition is satisfied (block 62). According to one aspect of the invention, the similarity condition uses a correlation equation to compare two digital images. More specifically, a correlation equation is used to compare answer regions in a test-taker's marked copy to corresponding answer regions of an unmarked version of a problem or test. Because the comparison of two answer regions, one scanned from a test-taker's copy and one from an unmarked version, such as a master copy, may not be perfectly aligned, a difference map generated from a comparison of the two may carry misalignment information instead of the marks made by the test-taker. A similarity measure tiled over the answer region can reduce such errors, including noise. Although it will be appreciated that many alternative similarity measures may be used, according to one aspect of the invention, a similarity measure may be achieved via the following correlation equation:

$$λ = \frac{4 {σ}_{xy} \overline{xy}}{( {σ}_{x}^{2} + {σ}_{y}^{2} ) [ {( \overline{x} )}^{2} + {( \overline{y} )}^{2} ]}$$

where,

$$\overline{x} = \frac{1}{N} {\sum }_{i = 1}^{N} {x}_{i}$$

$$\overline{y} = \frac{1}{N} {\sum }_{i = 1}^{N} {y}_{i}$$

$${σ}_{x}^{2} = \frac{1}{N - 1} {\sum }_{i = 1}^{N} {( {x}_{i} - \overline{x} )}^{2}$$

$${σ}^{2} y = \frac{1}{N - 1} {\sum }_{i = 1}^{N} {( {y}_{i} - \overline{y} )}^{2}$$

$${σ}_{xy} = \frac{1}{N - 1} {\sum }_{i = 1}^{N} ( {x}_{i} - \overline{x} ) ( {y}_{i} - \overline{y} )$$

A correlation equation like the one provided above, as is known in the art, indicates how similar one pixel region is to another. Therefore, they do not execute a pixel by pixel comparison of two images, but consider pixels immediately around each pixel. In the above equations, xᵢ,yᵢ is the i^{th} pixel from the respective answer regions of the marked copy and unmarked version. For a pixel position x,y, λ gives an indication as to the similarity of two different answer regions for that pixel position, where the similarity considers adjacent pixels within a predetermined block N. Thus, as used above, N is a block size (e.g., 25 pixels for a 5 by 5 block) that defines the area considered around each pixel.

Using the above equations, if two compared answer regions are identical, λ, which may be referred to as the similarity index, would be equal to 1. On the other hand, if two answer regions are dissimilar, the similarity index would be less than 1. These values are used to generate a similarity map that illustrates how similar an answer region of the marked copy is to a corresponding answer region on the unmarked version. Once λ is calculated for each pixel position in the similarity map, an inverse of λ is taken (1−λ), which provides a weighted value for each pixel x,y. Therefore, for a given pixel position, 0 would indicate that the position is identical in the two compared answer regions.

Next, a center of gravity of each answer region in the similarity map may be computed, as is well known in the art. For each multiple choice question, the answer recognition method will then determine the center of gravity that is closest to the location of an answer letter. According to one aspect of the invention, the center of gravity that is closest to an answer letter may be used to identify the test-taker's selection. According to one aspect of the invention, the center of gravity has to be within a certain distance from the location of an answer letter, or the similarity condition will not be met. If the similarity condition is satisfied (block 62), the test-taker's answer for the question is stored (block 66).

If the similarity condition is not satisfied, the answer recognition method will repeat each of the three conditions, but only after the answer region is increased in size (block 64). As noted above, if the answer regions become too large, it may be difficult to perfectly align the marked-copy with the unmarked version to execute a comparison between answer regions. However, using incremental increases in size, in combination with the above conditions, effectively identify a test-taker's answer without negative impact from scanning distortion, discrepancies between the marked copy and unmarked version, and the like. According to one aspect of the invention, the answer region is progressively dilated until one of the conditions is met, where the answer region is enlarged by a small percentage each time. For instance, a five pixels increase may be implemented.

It will be appreciated by one of ordinary skill in the art that the difference, ratio and similarity conditions may be processed in a different order than is presented in FIG. 5. For instance, the ratio condition may be considered prior to the difference condition. Nevertheless, it is preferred that the similarity condition occur last, as it is computationally more intensive. According to another embodiment, only one or two of the conditions may be implemented, as all three are not required to accurately identify most answers. Nevertheless, it is preferred that the answer region size be increased if each of the conditions fail to identify the test-taker's answer.

According to another embodiment of the present invention, a test sheet may be created with circling guides in an effort to avoid the problem presented by an over-drawn answer circle, as in the illustrative example of FIG. 3. More specifically, the circling guides may be printed on a test as guides for a test-taker to use in drawing circles around selected answer choices. For instance, the circling guides may be traced by a test-taker to ensure that a circular answer marking resides totally within an answer region corresponding to the test-taker's selected answer. Therefore, it is preferred that testing instructions alert the test-taker to mark answer selections as accurately as possible with the aid of the circling guides so that the test may be accurately graded.

According to one aspect of the invention, the circling guides may be printed on a test sheet as a thin or faint circular line that is not distracting to a test-taker. The circling guides may also be printed using a dashed or dotted line, or the like, such that they are not continuous around each answer choice. It will also be appreciated that the circling guides may take the shape of a square, rectangle, oval, or the like, or portions thereof. Furthermore, the circling guides may identify the boundaries of each answer region to encourage test-takers to mark answers entirely within the answer region.

The circling guides will preferably appear on both the unmarked version of a test and the test-taker's marked copy of the test. Because the circling guides appear on both versions, the circling guides may not appear in a difference map generated by a direct pixel map comparison of an unmarked test and a test-taker's marked copy. Therefore, the use of circling guides may be used in conjunction with the methods described above with respect to FIG. 5. Alternatively, because circling guides result in answer markings appearing entirely within an answer region, the use of circling guides may be used in conjunction with the methods for identifying answer selections as described above with respect to FIGS. 1 and 2.

Next, it will be appreciated that each of the methods described above with respect to FIGS. 1-5 may be implemented by computer software and/or hardware, as described next with reference to FIG. 6. FIG. 6 shows a block diagram of an answer recognition module 70, according to one aspect of the present invention. As illustrated in FIG. 1, the answer recognition module 70 generally includes a processor 72, operating system 74, memory 76, input/output (I/O) interface 82, database 84 and bus 80. The bus 80 includes data and address bus lines to facilitate communication between the processor 72, operating system 74 and the other components within the module 70, including the answer identification tool 78, the input/output interface 82 and the database 84. The processor 72 executes the operating system 74, and together the processor 72 and operating system 74 are operable to execute functions implemented by the answer recognition module 70, including software applications stored in the memory 76, as is well known in the art. Specifically, to implement the methods described herein with respect to FIGS. 1-5 the processor 72 and operating system 74 are operable to execute the answer identification tool 78 stored within the memory 76. According to one aspect of the invention, the answer identification tool 78 may include one or more algorithms for executing the methods and processes described above with respect to FIGS. 1-5.

It will be appreciated that the memory 76 in which the answer identification tool 78 resides may include random access memory, read-only memory, a hard disk drive, a floppy disk drive, a CD Rom drive, or optical disk drive, for storing information on various computer-readable media, such as a hard disk, a removable magnetic disk, or a CD-ROM disk. Generally, the answer identification tool 78 receives information input or received by the answer recognition module 70, including digital versions of the marked and unmarked answer sheets. The answer identification tool 78 also receives answer letter and answer region data 86, which identifies the location of the answer letters and answer regions for each answer choice for each multiple choice test question. According to one aspect of the invention, the answer letter and answer region data may be stored local to the answer recognition module 70, such as in the database 84, although the data may also be received from one or more remote sources via the I/O interface 82. Using information it receives, the answer identification tool 78 effects the methods described in detail above with respect to FIGS. 1-5 to identify user-selected answers. Therefore, the answer identification tool 78 may be operable to execute computations, compare digital images, generate difference maps, count pixels within maps, process information, and the like, as needed to execute the methods described herein.

Referring again to FIG. 6, the processor 72 is in communication with the I/O interface 82 to control and communicate with I/O devices. Typical user I/O devices may include a video display, a keyboard, a scanner, a mouse or other input or output devices. Additionally, the I/O interface 82 may provide one or more I/O ports and/or one or more network interfaces that permit the answer recognition module 70 to communicate with other network devices. According to one aspect of the invention, the answer recognition module 70 may transmit data to remote sources, such as via a LAN, WAN, the Internet, or the like, to send and receive answer letter and answer region data 86, to receive digital images of a marked copy and unmarked version of a question or test, and to transmit test-taker answer data. Therefore, the I/O interface 82 may also include a system, such as a modem, for effecting a connection to a communications network.

The database 84 of the answer recognition module 70, which is connected to the bus 80 by an appropriate interface, may include random access memory, read-only memory, a hard disk drive, a floppy disk drive, a CD Rom drive, or optical disk drive, for storing information on various computer-readable media, such as a hard disk, a removable magnetic disk, or a CD-ROM disk. In general, the purpose of the database 84 is to provide non-volatile storage to the answer recognition module 70. As shown in FIG. 6, the database includes one or more tables, segments or files within the database 84 to store answer letter and answer region data 86 and test-taker answer data 88. The answer letter and answer region data 86 may be used by the answer recognition module 70, and more particularly, the answer identification tool 78, to execute the functions described herein to identify test-takers' answers, which may be stored as test-taker answer data 88 within the database 84. Although not illustrated, the database 84 may also store digital images, such as difference maps, similarity maps, and the like, used to execute the processes described above.

It is important to note that the computer-readable media described above with respect to the memory 76 and database 82 could be replaced by any other type of computer-readable media known in the art. Such media include, for example, magnetic cassettes, flash memory cards, digital video disks, and Bernoulli cartridges. It will be also appreciated by one of ordinary skill in the art that one or more of the answer recognition module 70 components may be located geographically remotely from other answer recognition module 70 components. For instance, the answer letter and answer region data 86 may be located geographically remote from the answer recognition module 70, such that historical data and lookup tables are accessed or retrieved from a remote source in communication with the answer recognition module 70 via the I/O interface 82.

It should also be appreciated that the components illustrated in FIG. 6 support combinations of means for performing the specified functions described herein. As noted above, it will also be understood that each of the methods described above, including the processes and computations described with reference to FIG. 5, can be implemented by special purpose hardware-based computer systems that perform the specified functions or steps, or combinations of special purpose hardware and computer instructions. Further, the answer recognition module 70 may be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Additionally, although illustrated individually in FIG. 6, each component of the answer recognition module 70 may be combined with other components within the answer recognition module 70 to effect the functions described herein. Accordingly, the answer recognition module 70 may take the form of an entirely hardware embodiment, an entirely software embodiment or an embodiment combining software and hardware aspects, such as firmware.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of identifying a user-selected answer, comprising:
scanning a marked copy of an answer sheet, wherein the marked copy includes a marking corresponding to a user-selected answer of a plurality of answer choices;
comparing at least one portion of the marked copy to a corresponding at least one portion of an unmarked version of the answer sheet;
identifying differences between the at least one portion of the marked copy and the corresponding at least one portion of the unmarked version; and
based on the identified differences, determining the user-selected answer.

2. The method of claim 1, further comprising the steps of:
generating a digital pixel map of the unmarked answer sheet; and
generating a digital pixel map of the marked copy.

3. The method of claim 2, wherein the step of comparing comprises the step of comparing at least one answer region of the marked copy to a corresponding answer region of the unmarked version, wherein the respective answer regions of the marked copy and unmarked version encompass at least one of the plurality of answer choices.

4. The method of claim 3, wherein the step of comparing comprises the step of comparing a digital pixel map of the answer region of the marked copy to a digital pixel map of the corresponding answer region of the unmarked version.

5. The method of claim 2, further comprising the step of creating a difference map, wherein the difference map shows at least some of the differences between the marked copy and the unmarked version.

6. The method of claim 5, wherein the step of creating a difference map comprises creating a digital difference map that identifies at least some of the pixel differences between the digital pixel map of the marked copy and the digital pixel map of the unmarked version.

7. The method of claim 5, wherein the step of creating a difference map comprises the step of creating a digital difference map that identifies the pixel differences between an answer region in the digital pixel map of the marked copy and a corresponding answer region in the digital pixel map of the unmarked version.

8. The method of claim 7, further comprising the step of determining the number of pixels that are different in the answer region of the marked copy compared to the corresponding answer region of the unmarked version.

9. The method of claim 1, wherein the step of identifying differences further comprises the step of measuring the similarity between the at least one portion of the marked copy and the corresponding at least one portion of the unmarked version, wherein the similarity measurement is based on a correlation computation.

10. A method of identifying user-selected answers, comprising:
scanning an answer sheet, wherein the answer sheet includes at least one marking corresponding to a user-selected answer;
comparing a first region of the scanned answer sheet to a corresponding first region of an unmarked version of the answer sheet;
identifying the differences between the first region of the scanned answer sheet and the corresponding first region of the unmarked version of the answer sheet; and
determining the user-selected answer based on the identified differences.

11. The method of claim 10, further comprising the step of comparing a second region of the scanned answer sheet to a corresponding second region of the unmarked version of the answer sheet.

12. The method of claim 11, further comprising the steps of:
establishing a first rank based on the identified differences between the first region of the scanned answer sheet and the corresponding first region of the unmarked version of the answer sheet; and
establishing a second rank based on the identified differences between the second region of the scanned answer sheet and the corresponding second region of the unmarked version of the answer sheet.

13. The method of claim 12, wherein the step of determining the user-selected answer comprises the step of determining the user-selected answer by comparing the first rank and the second rank.

14. The method of claim 10, wherein the step of identifying the differences further comprises the step of generating a difference map based on the identified differences between the first region of the scanned answer sheet and the corresponding first region of the unmarked version of the answer sheet.

15. The method of claim 10, wherein the step of identifying the differences further comprises the step of determining the number of pixels that are different in the first region of the scanned answer sheet compared to the corresponding first region of the unmarked version of the answer sheet.

16. The method of claim 15, further comprising the steps of:
comparing a second region of the scanned answer sheet to a corresponding second region of the unmarked version of the answer sheet; and
determining the number of pixels that are different in the second region of the scanned answer sheet from the corresponding second region of the unmarked version of the answer sheet.

17. The method of claim 16, wherein the step of determining the user-selected answer comprises the step of determining the user-selected answer by comparing:
the number of pixels that are different in the first region of the scanned answer sheet to the number of pixels that are different in the second region of the scanned answer sheet.

18. The method of claim 10, further comprising the step of storing the location of answers on the answer sheet.

19. The method of claim 10, further comprising the step of storing the location of the corresponding first region of the unmarked version of the answer sheet.

20. The method of claim 19, further comprising the step of increasing the size of the first region of the scanned answer sheet and the corresponding first region of the unmarked version of the answer sheet.

21. A method of identifying a user-selected answer, comprising:
providing a marked copy of an answer sheet, wherein the marked copy includes a circling guide, and wherein the marked copy includes a marking corresponding to a user-selected answer of a plurality of answer choices;
comparing at least one portion of the marked copy to a corresponding at least one portion of an unmarked version of the answer sheet;
identifying differences between the at least one portion of the marked copy and the corresponding at least one portion of the unmarked version; and
based on the identified differences, determining the user-selected answer.

22. The method of claim 21, wherein the at least one circling guide defines an area within the at least one portion of the marked copy.

23. The method of claim 21, wherein the at least one circling guide substantially corresponds to the at least one portion of the marked copy.

24. The method of claim 21, wherein the step of comparing includes comparing the at least one portion of the marked copy to the corresponding at least one portion of an unmarked version of the answer sheet, and wherein the unmarked version includes a circling guide corresponding to the circling guide on the marked copy.
